(19) United States
(12) Patent Application Publication
(10) Pub. No.: US 2016/0086290 A1
(43) Pub. Date: Mar. 24, 2016

(54) SOCIAL PROJECT MANAGEMENT

(71) Applicant: ACONEX LIMITED, Melbourne (AU)

(72) Inventor: Bernard BLAKE, Alberfeldie (AU)

(21) Appl. No.: 14/785,382

(22) PCT Filed: Apr. 19, 2014
(86) PCT No.: PCT/AU2014/000460

§ 371 Date: Oct. 19, 2015

Related U.S. Application Data
(60) Provisional application No. 61/813,938, filed on Apr. 19, 2013.

(51) Int. Cl. G06Q 50/00; G06Q 20/10; G06Q 30/02; G06Q 10/10

(52) U.S. Cl. CPC G06Q 50/01; G06Q 10/10; G06Q 20/102; G06Q 30/0201

(57) ABSTRACT

A computer implemented method comprising: storing data associated with a project in a data store, associating at least one user with the project using at least one data type and providing a communication tool to enable the user to communicate to another person about the project.

### CRASS REFERENCE TO RELATED APPLICATIONS

The current patent application is a National stage application No. PCT/AU2014/008460 filed on Apr. 19, 2014, which claims priority to U.S. provisional application 61/813,938 filed on Apr. 19, 2013.

### BACKGROUND OF THE INVENTION

People who undertake a project often want to communicate more easily with others involved in the project and to share aspects of the project with family and friends.

Some projects are substantially done by other parties, such as building a home, fixing up an old car, community projects, etc. In these situations the project owners typically experience loss of control over their projects and the anxiety caused by lack of information. In addition, project owners typically wish they could more readily share the latest information, images and so on about their project with friends and family.

At the same time, the people in charge of getting such a project done (“project doers”) typically feel berated by owners who are constantly bugging them for more information.

In some instances, the project doer feels that if the owner would just let them get on with the job rather than answering their queries, they would have the job completed much more quickly. Project doers also need a simple, intuitive way to record the decisions from owners and to track information, specifications etc. They also often need to share large files with owners and this is currently difficult.

The reference to any prior art in this specification is not, and should not be taken as, an acknowledgement or any form of suggestion that the prior art forms part of the common general knowledge.

### SUMMARY OF THE INVENTION

According to one aspect of the invention, there is provided a project management system comprising at least one social media tool to increase the effectiveness of communicating information associated with the project.

In another aspect, there is provided a computer implemented method comprising: storing data associated with a project in a data store, associating at least one user with the project using at least one data type, and providing a communication tool to enable the user to communicate to another person about the project.

In one aspect of the invention there is provided a project management system comprising: a processor executing instructions stored on a memory; and the memory comprising: a data storage module configured to store information about a project; a user data module configured to associate at least one user with the project, using at least one data type and a communication module to enable the user to communicate to another person about the project.

In another aspect of the invention, there is provided a computer implemented method for communicating about a project comprising: outputting by a server device an information interface for display by a client device and thereby providing a user with the ability to communicate about a project; receiving by a server device at least one instruction from the user in relation to the project; and enabling a communication about the project.

In yet another aspect of the invention, there is provided an apparatus, comprising: a storage device; and a processor coupled to the storage device, wherein the storage device stores a program for controlling the processor, and wherein the processor, being operative with the program, is configured to cause output by a server device of an information interface for display by a client device and thereby providing a user with the ability to communicate about a project; receiving by a server device at least one instruction from the user in relation to the project; and enabling a communication about the project.

In another aspect of the invention, there is provided a computerized system for social project management comprising: a project module to manage registration of projects on the system; a messaging module to enable a user to send messages and keep track of conversations; a document module to allow for the management of documents; and a milestone module to manage the schedule and/or milestones for each project; In some embodiments, the system of this aspect optionally further comprises one or more of: a billing module to manage billing; a social module to enable a user to push notifications and events to social media; a decision registry to maintain one or more decisions that have been made during the process; and a packaging module to produce a report. In some embodiments the messaging module is the social module.

Some embodiments of the system comprise one or more of: a billing module to manage billing; a social module to enable a user to push notifications and events to social media; a decision registry to maintain one or more decisions that have been made during the process; and a packaging module to produce a report.

Some embodiments of methods of the invention comprise the step of associating a plurality of projects with one another.

Some embodiments of the system comprise at least one search module to enable search.

Some embodiments of methods of the invention comprise the steps of receiving a search instruction via a user interface; conducting a search according to the search instruction and optionally a predefined criterion; and displaying one or more search results. In some embodiments, the predefined criterion comprises a restriction based on the user's access privileges. The search may be optionally: across one or more projects: for a user, a document, a type of project. In some embodiments the search is for a user to collaborate with or to provide a service.

Some embodiments of the system comprise a rating module to enable a first user to add information about a second user wherein the information is optionally rating information and/or recommendation information and the second user is optionally a service provider or a collaborator.

Some embodiments of methods of the invention comprise the step of receiving from a first user, information relevant to a second user wherein the information optionally comprises rating information and/or recommendation information and wherein the second user is optionally a service provider or a collaborator.

Some embodiments of the system comprise a marketing module to enable marketing messages to be displayed in the system.

Some embodiments of methods of the invention comprise the steps of receiving and/or collecting marketing information relevant to one or more users and/or one or more projects; receiving at least one instruction in relation to marketing; and displaying a marketing message to a user wherein the marketing message is optionally displayed once a predetermined criterion is met.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1 depicts a schematic of an example implementation of the system of the invention.

FIG. 2 depicts a process flow chart of an example implementation of the method of the invention.

FIG. 3 depicts some example users in an example implementation relating to construction of residential buildings as described herein.

FIG. 4 depicts an example web-based display for the implementation of FIG. 3.

FIG. 5 depicts an example mobile implementation and an example mobile alert for the implementation of FIG. 3.

FIG. 6 depicts an example implementation of internal and third party components of the system and method of the invention.

FIG. 7 depicts an example email with links to the system of the implementation of FIG. 3.

FIG. 8 depicts an example facebook notification with questions and answers in relation to the implementation of FIG. 3.

FIG. 9 depicts an example high level technical architecture according to certain embodiments.

FIG. 10 is a class diagram of the high level components of certain embodiments of he invention.

FIG. 11 is a state transition diagram of milestones according to the exemplary embodiments of FIG. 10.

FIG. 12 is an interaction diagram depicting an example process flow fore user signing in.

FIG. 13 is an interaction diagram depicting an example process flow for a builder registering a new project in some exemplary embodiments.

FIG. 14 is an interaction diagram depicting an example process flow for certain messaging and information sharing options according to some exemplary embodiments.

FIG. 15 is an interaction diagram depicting an example process flow for configuring and publishing building milestones according to some exemplary embodiments.

FIG. 16 is an interaction diagram depicting an example process flow for collaborating on documents and milestones according to some exemplary embodiments.

FIG. 17 is an interaction diagram depicting an example process flow for packaging and reporting according to some exemplary embodiments.

### DETAILED DESCRIPTION OF EXEMPLARY EMBODIMENTS

It is convenient to describe the invention herein in relation to particularly preferred embodiments. However, the invention is applicable to a wide range of options and it is to be appreciated that other constructions and arrangements are also considered as falling within the scope of the invention. Various modifications, alterations, variations and/or additions to the construction and arrangements described herein are also considered as falling within the ambit and scope of the present invention.

The invention herein described can be used in relation to any project in which a person is interested. It tends to work better where more than one person is involved, but this is not crucial. In those embodiments in which a single user is involved in a project, the user may still gain benefit from use of the system by utilizing the communication tools such as social media tools to communicate information about the project to one or more third parties.

By way of example only, the invention may be used for construction projects, such as building projects for example for commercial or residential purposes or land-related projects such as landscaping or clearing. It may also be used for transport-related projects, such as car maintenance, or building a new car or airplane or boat (for example from a kit). It may be used for creative projects, hobbies etc.

In some embodiments, the invention is used in connection with the repair and for maintenance of an item or thing, which could be anything from an old couch, to a car, a house, etc. Such projects might for example comprise renovation, upgrading, additions to the item, and so on.

The invention may equally be used for other types of projects, for example creative projects. Thus for example, a user may wish to manage the production of a patchwork quilt or creation of a painting or a sculpture or a new garden area, or anything at all. The invention enables the user to communicate readily in relation to collaborating on the project and also readily share information, updates, images, video etc. with others as he or she wishes.

In another example, in some embodiments the invention may be used for planning, for example planning a holiday, a move, a trip, a new enterprise, etc.

In some embodiments one or more projects may be associated together for example to form groups or series. They may be associated in any suitable fashion. For example, a user may associate all of the groups that he or she has been involved in together. Alternatively, a company managing multiple projects may group them together. In some embodiments, projects may be grouped together based on tags, keywords or categories. This may be done by individual users so that they can collect together particular projects of interest (in such situations certain embodiments will only let them view information that is available to them—either via permission granted, or because the information has been made public by a user with relevant authority).

A user may be associated with a project according to the invention in any suitable way. In some embodiments a simple table is created in which a user identity is associated with a project identifier. Data types which may be used to associate a user may comprise any suitable type, for example a unique identifier, a name, login details, an address, a phone number, an email address, a social media ID etc.

Some embodiments of the invention provide for varying levels of access and control. In some implementations, there is an overall administrator level to manage the overall system. In some implementations various levels of access may be granted to one or more users within a project or group of projects. Access levels may for example comprise:
Tagged Only—to receive and view only information tagged for that user
Read Only—to view anything within a project or group of projects but not add new content or edit
Contributor—the same rights as Read Only, plus the ability to add new content, but not edit.
Editor—the same rights as Contributor,plus the ability to edit content from any user.
Administrator—the same rights as Editor plus the ability to set permissions and levels of access and control for other users.

Communication with the invention can be by any suitable means. In some embodiments, the system provides a plurality of views to enable a user to more readily undertake a particular action or task. For example, in some implementations there may be a dashboard view which displays the vital statistics for a project (or for example a range of projects), equally there may be other views, such as a calendar or timeline, showing milestones, past events, due dates, etc. in some embodiments an event stream is included and in such embodiments this may comprise all or most of a separate view.

In some embodiments the system of the invention further comprises at least one search module to enable search. Search may be across one or more projects. Search may also be for other elements such as users, documents, types of projects and so on. Search may be restricted to pre-defined limits—for example only those to which a user has access.

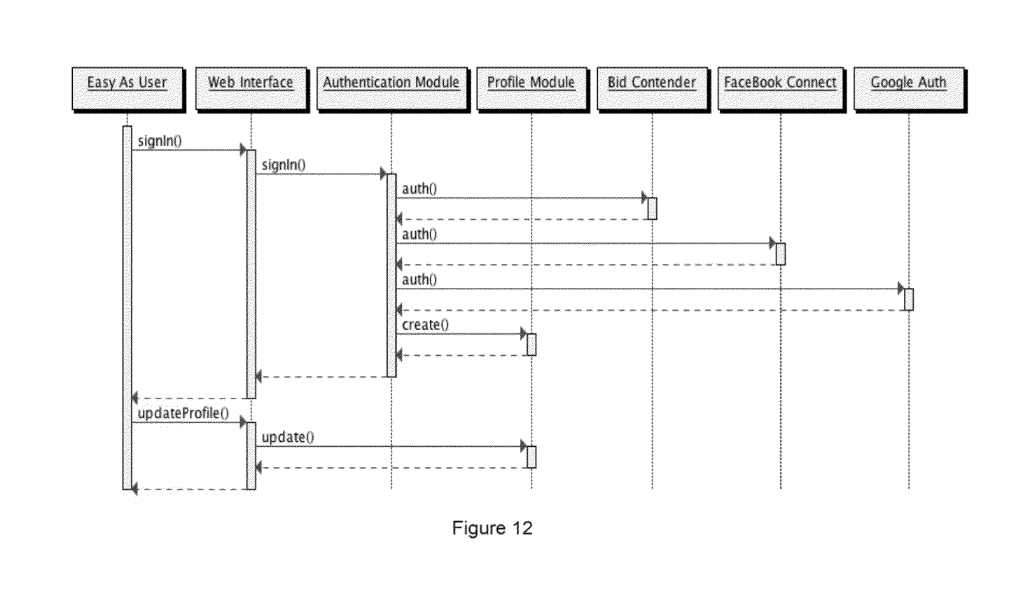

In some embodiments, the invention enables a user to search and find another type of user to perform a role in relation to the project (a non-limiting example is the ‘Bidcontender’ in FIG. 12). This may be any suitable role, for example it may be to collaborate (for example on a creative endeavor), but it could equally be to perform paid services in relation to the project (for example a builder, or plumber on a residential construction project). Embodiments comprising this functionality may also comprise a separate view to enable ready searching and filtering of prospective users to add to the project.

Those embodiments that enable a user to add further users may also provide systems and methods for choosing amongst potential additional users. For example, in some embodiments, service providers may collect together a portfolio of their work for display to users searching for their types of services. In some embodiments, a service provider's entire work history within the system and method of the invention are recorded and non-confidential aspects are displayed. In some embodiments, a service provider or user can curate their work history to present it in the best possible light.

In some embodiments users may rate service providers or other users during or after a project and such ratings may for example be used to attract further work or collaborations or participation in future projects. Equally, service providers may be able to rate and comment on users who have used their services, for example whether they paid on time, whether they were good to deal with, etc. In some embodiments users may elect to be contactable by future prospective users of a service provider in order to obtain information about the service provider to for example inform a choice of service provider. The same functionality can be used for other users (for example to collaborate or participate in a project) or indeed for service providers to enquire about a prospective purchaser of their services.

Some embodiments comprise a recommendation module to handle information about users and enable recommendations to be made by other users. Some embodiments provide a contacts management module which may for example be associated with one or more external platforms specialised in contacts and their information, for example LinkedIn, facebook, MySpace and the like.

Some embodiments of the invention allow marketing messages to be displayed in the system. In some embodiments the marketing messages are in the form of targeted ads, for example based on the type of project, key words in communications about the project, the past purchasing history of the user etc.

Communication in relation to use of the system and method of the invention can be by any suitable means. In some embodiments it comprises using text in mobile, internet or local computer devices, but in others it comprises one or more of audio, images, video, text, etc. Any suitable communication method can be used, including email, sms, facsimile, voice recording, voice to text and text to voice and so on.

In some embodiments the invention comprises one or more social media elements to enhance communication. In some embodiments such elements are built in to the system, for example an event stream, commenting, opinions, ‘liking’, chat rooms, messaging, and so on. In some embodiments there is an event stream that captures every event in the project in chronological order.

In some embodiments, the system and method of the invention may be used in conjunction with one or more external platforms such as social media platforms. In such embodiments, users may be able to elect which social network platforms to connect with and when permissions are provided, the system may connect via an API. In such embodiments, the user may be able to easily share information about the project on one or more of such platforms and for example obtain feedback or comments. Examples of platforms that a user may for example connect to according to such embodiments may for example include: facebook, Google+, Twitter, LinkedIn, MySpace, LiveJournal, Pinterest, Cafemom, Tagged, Ning, Meetup, Bado, myLife, Orkut, Youtube and so on.

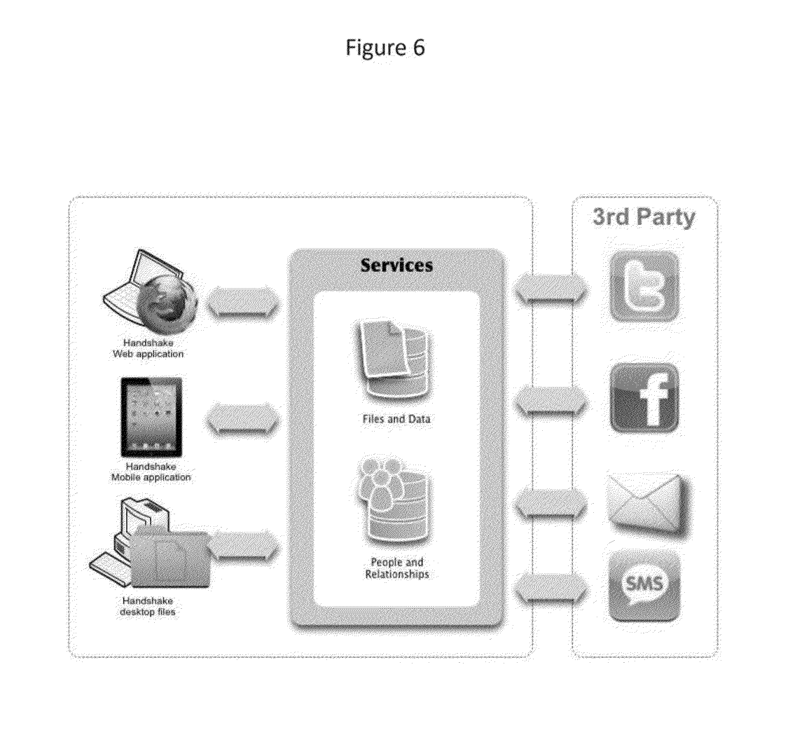

FIG. 6 depicts a simplified embodiment in which elements include a web application, a mobile application and a desktop system particularly suitable for file handling, services including handling files and data and people and relationships and external platforms including twitter, facebook, email and sms.

In some embodiments users can create information within the system or method of the invention from outside it, for example by sending an email or other communication to a particular address or via a communication protocol so that the information is captured by the system of the invention. In some embodiments such information may be categorised by the system automatically and it may for example be tagged with relevant tags, for example the identity of the sender and recipients and/or tagged based on key words. In some embodiments, tasks, milestones and other items can be created in this way.

Information shared in the system and method of the invention may be captured in a variety of ways. In some embodiments every communication is captured and tagged with relevant tags, for example with the identity of the sender and of all of the receivers as well as with key words. In some embodiments users can add their own tags and/or categories for example to make browsing or filtering of data simpler later.

In some embodiments users may select sharing options using one or more privacy settings, for example a particular piece of information or a category of information (for example with a particular tag) may only be shared with specified people or a specified set of people (eg with a particular tag or grouping). In some embodiments in which one or more organisations may collaborate, sharing settings may enable information relevant to the organisation to be shared across all users within the organisation, or for example all users with a particular permission setting within the organisation.

Some embodiments of the invention comprise data protection measures. For example in some embodiments a user can not delete an item of information. In other embodiments, a user can only delete an item of information with the permission of all users that have sent or received it or have access to it. In some embodiments, all information is stored, but public availability of certain types of information can be modified by the originator of the information. This may for example occur when an architect issues a new edition of a plan and wishes to ensure that all users are looking at the latest version. They may restrict access to the previous version or remove it from public view until the end of the project.

In some embodiments the system and method of the invention comprises a task module to enable users to set tasks for themselves or others working on the project. Tasks may be set as milestones which may be linked to another event, for example a progress payment, a celebration, a notification or any suitable event. In some embodiments tasks can be shared with other users who may collaboratively complete them.

In some embodiments the invention provides status updates, which can be displayed in any suitable fashion. For example, they may be displayed in a news area on a web page, as pop ups on a web page, as the latest item in an event stream, as a text or sms message sent to a mobile device, as an email and so on. Preferably users can select various options in relation to status updates such as the type and frequency and how they wish to be made aware of them. Status updates can be in respect of any suitable information, such as completion of tasks or milestones, smaller events, etc.

In some embodiments of the invention the system stores all historical data (including files) and thereby serves as a secure data store for the history of the project or for example a series of projects. This can be particularly useful in working through disputes for example in relation to specifications or assignment of tasks or scope of responsibilities in relation to one or more projects. This can also be useful for project owners if they wish to keep a representation of the history of the project, for example as a momenta.

Information shared within or external to the system of the invention can be treated in a social way to enable better communication. For example, opinions such as likes, dislikes, numerical scores, reviews, requests for opinions can all be used.

In some embodiments the system comprises a resource tracker to track resources required for the project. Such a resource tracker may track any suitable resources (for example time, money, physical goods, raw materials, energy, etc) and track any suitable characteristics of the resources (for example, inventory amounts, cost, location, shipping time, key sources, etc.)

Some embodiments of the invention enable external information to be added to a project. This may be information automatically added (for example the results of a daily search using an Internet search engine such as the google search engine, or the weather in a location key to the project), or added by a user (for example a news item that is forwarded in to the project by a user).

In some embodiments the invention enables files to be readily transferred between users and in and out of the system. In some embodiments users may not delete a file.

Any suitable type of file may be transferred according to the invention, including for example plans, images, text files, documents, computer code, contracts, video, etc. Users may transfer files for any reason, for example for collaboration, comment, for instructions, simply to share, etc. The invention in some embodiments uses a modern fast-transfer protocol to increase the efficiency of transfer of large files.

Some embodiments provide a central store for files which may optionally provide version control to ensure that there are no inconsistent versions of documents. Some embodiments provide collaboration tools so that users may work together (whether simultaneously or not) on a document or file.

In some embodiments there is further provided a search function. The search function can be configured in any suitable manner. In some implementations it enables a user to search across all communication types and all users and all types of data and files based on key words, filters, tags and other search related criteria. Such a search function enables a user to get more from the system and its aggregated content. In some embodiments, search is restricted to only information for which a user has access.

Various modules may be used in a system and method according to the invention which may be of greater use in particular implementations. For example, in one embodiment a service provider user such as a builder may use a quoting module to create quotes based on set criteria relevant to the costs of undertaking a project (such as size, number of stories, materials to be used, timeframe required, etc). In other embodiments, modules may be included for payments between users and reminders about payments.

Some embodiments comprise a completion module which guides users through all of the steps to be taken to finalise, cross check (eg. for quality) and sign off on completion of a project. Such a module preferably reminds the different users at relevant times of the next step that they must do to enable completion to occur. This may be particularly important in some types of projects the process of completing the project must be carefully undertaken to comply with relevant laws and safety requirements. As an example, completion of a building or engineering project may require sign-off from various subject matter experts that the project outcome complies with relevant regulatory requirements. Similarly, before hand-over and final payment on a building project, an owner may have the option to undertake a final inspection and issue a final defect notice.

In some embodiments there is provided an analytics module to enable one or more types of analytics to be undertaken. Any suitable analytics may be done, for example characteristics of various users or projects in the system—such as the best (eg. highest rated/best feedback) service providers for eg. collaborators), the fastest service providers, those with the most successful projects, those with the highest customer satisfaction, etc. It may also provide a user with their personal statistics and in some embodiments suggestions as to how to improve them. In some embodiments an analytics module may be used to assist in matching one or more users for a particular project. Thus for example a user who needs a project done in a short time frame may be offered the services of the three fastest service providers for that type of project.

Similarly, a user who requires a project to be done with great detail may be offered the services of a service provider renowned for this quality.

### EXAMPLE 1

The invention is described below in relation to a non-limiting example in the residential construction industry.

This embodiment of the invention enables a home owner to readily communicate with a builder and all subcontractors about progress and management of the construction of their home as well as easily check for updates and share information, photos and other media with friends and relatives.

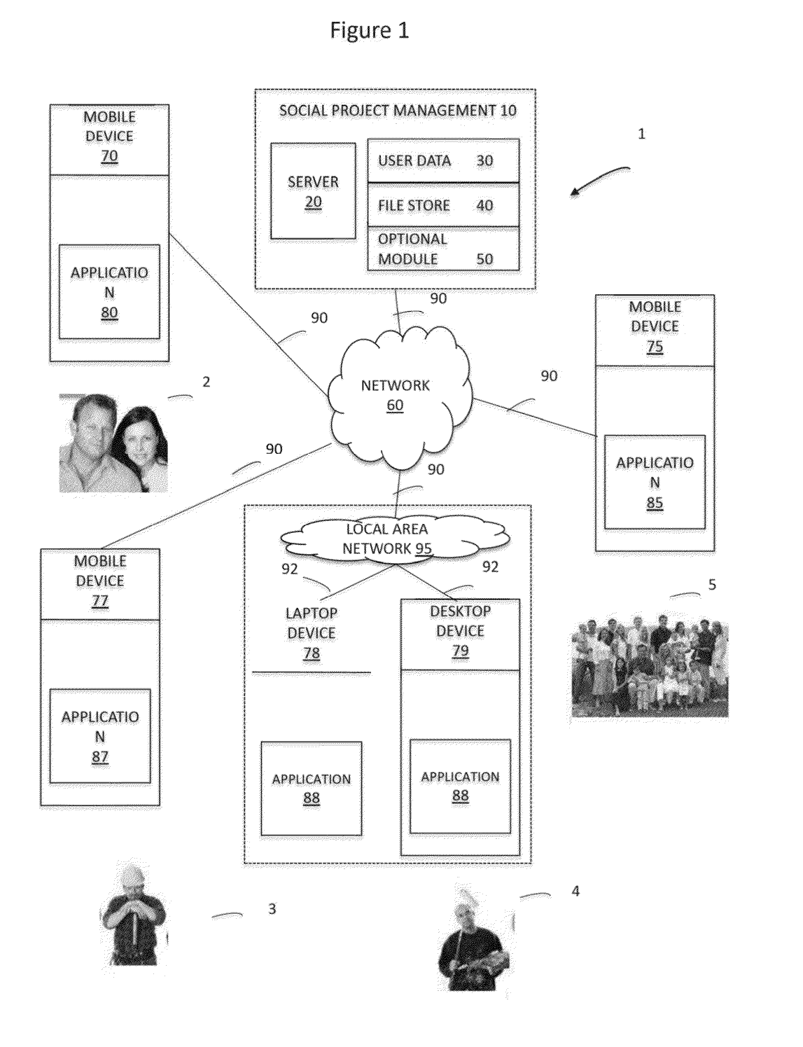

FIG. 1 depicts an example implementation of a system according to the invention shover generally at 1. In this embodiment, social project management system 10 comprises a server 20, with modules comprising a user data module 30, a file store 40 and an optional module 50. Any number of optional modules may be added to the system depending on the requirements of the application or use at hand. The optional module may be of any type depending on the configuration required. For example, in some embodiments it comprises a communication module to facilitate certain types of communication: such as by text, social media, sms or facsimile an din others it might comprise a recommendation module, a search module, a service provider search and/or rating module etc.

In some embodiments, an optional module may comprise an analyser to analyse data associated with one or more projects or users. Such a module may be used by a user to understand usage of the system and look for ways to improve efficiency in handling projects. Similarly such a module may be used to analyse marketing-related data to understand and increase the effectiveness of marketing efforts using the system of the invention. In still other embodiments an optional module may enable feedback such as reviews and ratings to be collected and shared in relation to one or more users. The skilled addressee will appreciate that other optional modules will be useful in certain situations.

System 10 communicates via connection 90 with network 60. Network 60 may be any suitable network, for example the internet. Communication connection 90 may be by any suitable means. According to this embodiment, system 10 has four sets of users, being home owners 2, builder 3, painter 4 and friends and family 5.

Builder 3 and painter 4 work for the same company and therefore use computing devices connected to the same local area network 95 which connects via connections 92 to the builder's laptop 78 and the painters desktop 79. Each of these devices is running a local version of software application 88 which communicates with system 10. In addition, builder 3 uses his mobile device 77 to utilize the system of the invention.

To do this he uses mobile version of the software application 87, which again enables him to communicate with and issue instructions etc, to System 10 via network 60 and connections 90. The builder can access any of his ongoing projects via mobile device 77 using application 87 and issue updates to owners, check on delivery of raw materials, share updates etc.

Home owners 2 access system 10 via their mobile device 70, which in this case is an ipad although any suitable mobile device (or indeed non mobile device) can be used Mobile device 70 comprises application 80 which is used to access, communicate with and issue instructions to system 10. Owners 2 can check updates from builder 3 or painter 4 and share them or other information with family and friends 5.

In this example, family and friends 5 also use a mobile device 75 to access the system 10, but in this case, the application 85 used to access the system is a simple web browser and they access a mobile version of the site directly from the internet 60.

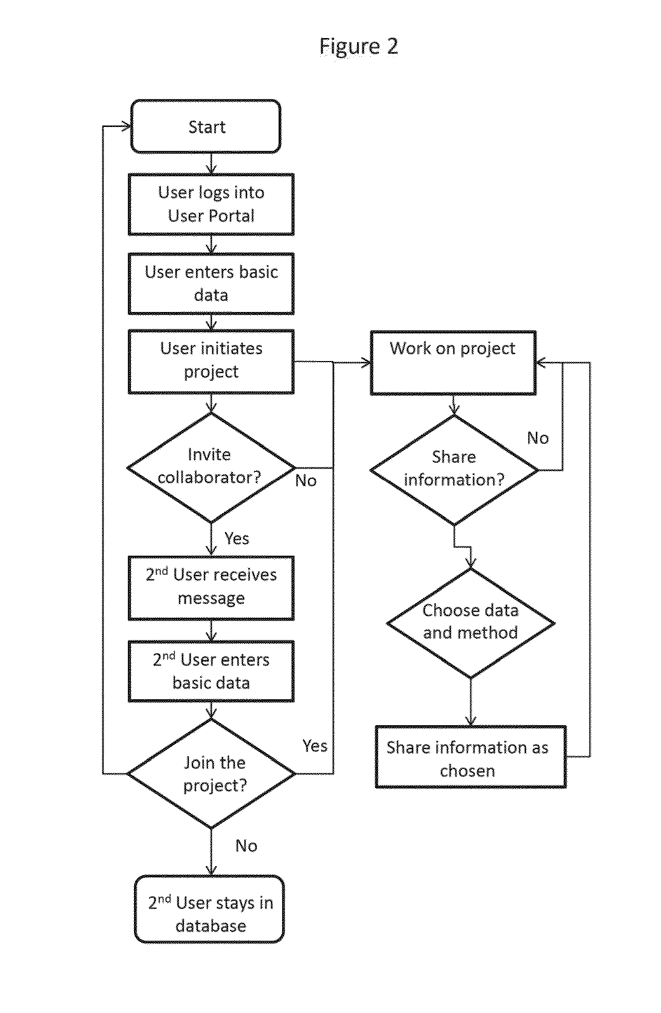

FIG. 2 depicts an example process flow for a simplified version of a method according to the invention in which a user logs in to a user portal, enters basic data and initiates a project. In this example, the user is asked whether he or she wishes to invite another person to collaborate on the project. (As described herein, a collaborator can be of any suitable type, and may for example be a builder who has been recommended to the user for building a new house.) If the user does not wish to invite another user to the project (for example if it is a solo project which they wish to simply track and share updates to family and friends from), then the user can proceed to start working on the project. If the user does invite a collaborator, the 2nd user is then invited to enter basic data, and then asked whether he or she wishes to join the project. If the 2nd user elects not to enter the project, he or she takes no further part but at least basic data is maintained on the database. If the 2nd User elects to join the project, then he or she will work on the project with the 1st user. At any point any of the users participating in a project may elect to share information by choosing the data or information or entering it and the method of sharing (eg. Email, Twitter, facebook, internal event stream etc) and sharing it.

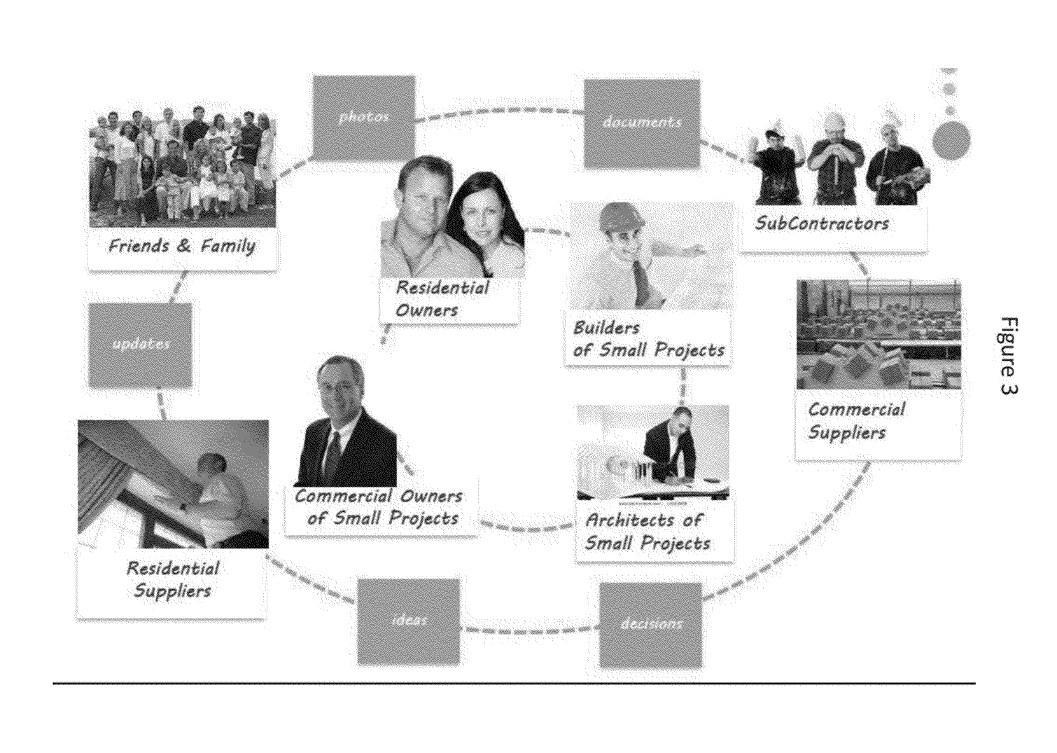

FIG. 3 depicts some example users of an implementation of this embodiment of the invention, As can be seen, owners, builders, commercial owners of projects, architects can all be easily linked using, a system and method of the invention. They can share updates, photos, documents, ideas, decisions and any other relevant information with each other or other relevant users such as friends and family subcontractors, suppliers and so on.

A system according to this embodiment provides an easy and familiar way to capture all of project-related inspirations, tasks, communication, images and files in a central place, using mobile and social tools. It is a social project management tool that is intuitive, fun and makes it easy to get everyone on the same page in order to move your project forward. It provides a central, social, engaging and real-time mobile tool that empowers builders to get the job done and allows the owner to come along for and share the ride.

For builders it provides questions and answers, but most importantly decisions, and all of their projects on their phone. For home owners, it provides questions, answers, decisions and memories—its the baby monitor for their project.

It also enables service providers such as builders, architects, plumbers, electricians etc to build up a history of successful projects for marketing purposes and makes it easier for them to manage inventory and scheduling tasks on the project.

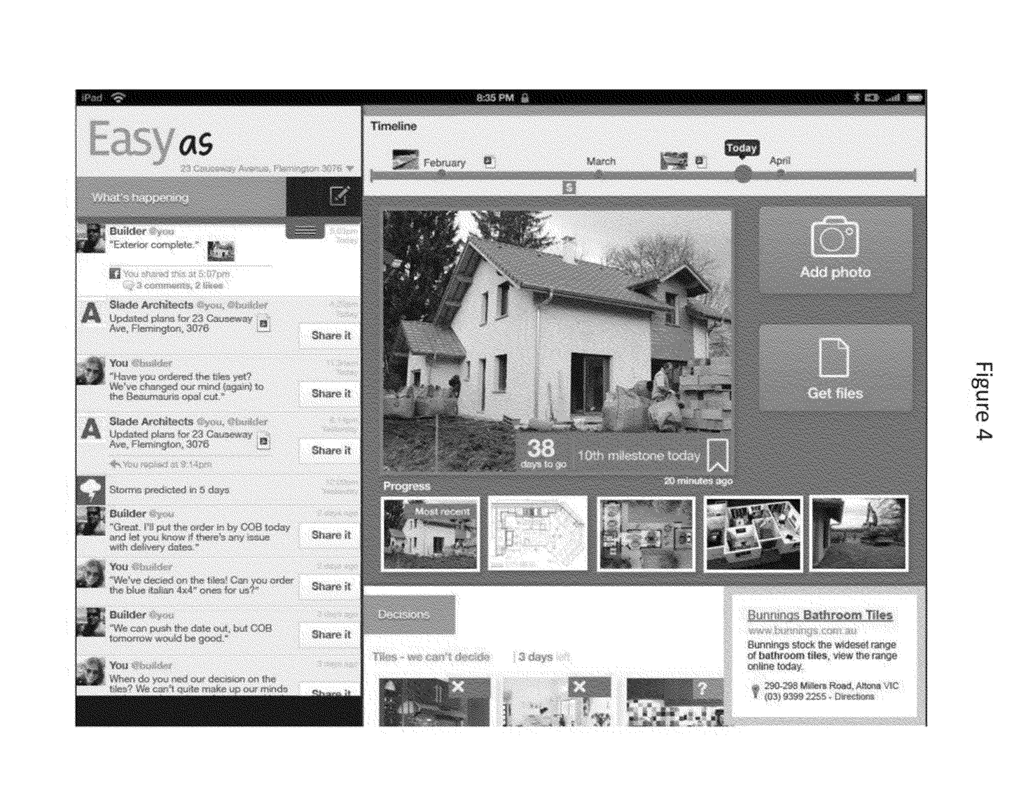

In this example, the system comprises a web interface, access from mobile devices as well as from desktop or laptop computing devices. FIG. 4 depicts an example implementation of a web interface for this embodiment of the invention. As can be seen, it comprises an event feed (with easy to use share buttons for sharing on other platforms), images and an image gallery, an area for providing or updating status or broadcasting messages. A timeline is clearly set out at the top of the display and is easily navigable by scrolling back and forth along the line. Photos and files can be added or retrieved using the buttons to the right of the display. In addition, in some implementations there may further comprise advertising or other marketing-related messages as depicted in the lower right corner of the display. It may be at least partially contextual—for example, the message or advertisement shown may be selected based on one or more key words from for example the event feed, or from comments that the user who is viewing the site has previously made.

The system captures a variety of electronic feeds (e.g. email, Twitter, Facebook) between participants into a cloud based collaboration platform, concurrent with the transmission via traditional applications. It provides an individual with the capacity to accumulate a vast trove of information over a lifetime of interactions, and then search and map those interactions in a way that delivers previously unachievable utility and amenity.

Advantages of this embodiment of the invention include:
Being accessible via the cloud, it provides a secure, redundant storage facility which can be used as an archive.
It stores communications in a network, allowing for storage economies (by only storing one copy of each communication, irrespective of the number of recipients) and enabling interaction mapping throughout a user's network.
It allows for aggregated search capability across a multitude of feeds with unlimited retrospectivity—no communication is ever deleted (unless every sender and recipient agrees).
It propagates via user driven network effects.
It allows for aggregation across organizations, allowing any member of that organization to see any shared communication, and complex dissection of the aggregated data by topic, participants and time.

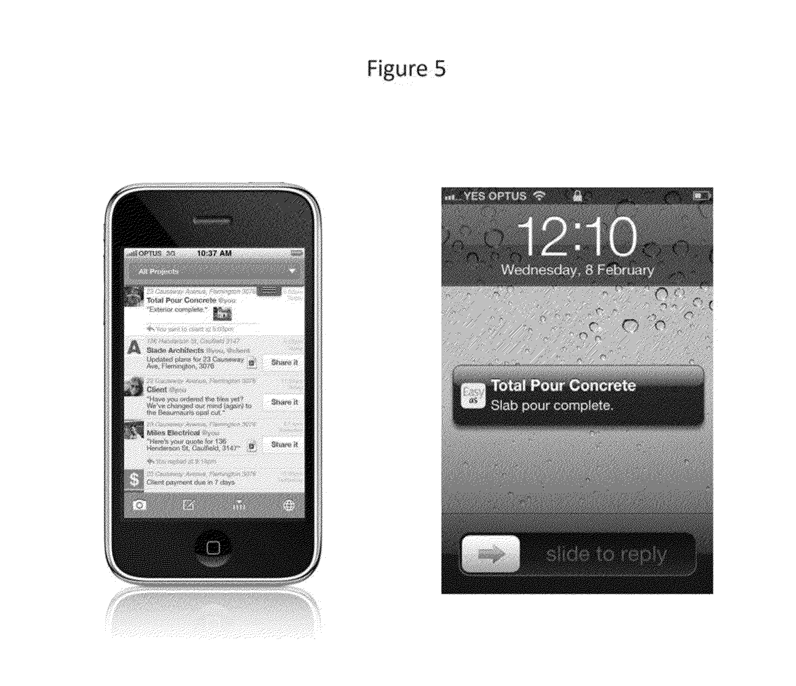

FIG. 5 depicts an example mobile implementation of this embodiment and in the image on the left, a view showing an event timeline. In addition, various alerts can be used, an example of an alert used on a mobile device is depicted to the right in FIG. 5. It will be appreciated that alerts can similarly be used for web-based or local (eg. Desktop) implementations.

According to this Example, owners can communicate and share their construction project with friends, family and associates and keep a record for posterity. By using the system of the invention, owners are able to feel more involved in a project and be able to see the status and ‘feel like they are there’ easily.

Builders are also able to increase their profit with greater efficiency. They can also elect to promote their completed projects and grow their reputation. This enables them to be more competitive in the market for building services.

Users of a system and method according to this aspect of the invention may for example comprise:
The owner who uses it to communicate with their builders, architects and the commercial owners of a larger scale project that it may be a part of.
Builders who use it to communicate with owners, the architects and commercial owners.
Commercial owners and Architects as above.
Friends and family of the owners who are shown photos and updates,for example notifications of milestones as they occur.
Subcontractors who are provided with documents, milestone dates, reminders etc.
Commercial suppliers who may for example provide an update on inventory and process orders via a system and/or method of the invention.

This embodiment of the invention provides users with a free tool that just works, to easily capture, back-up, search and map a complete record of all communications, so that they can manage the risk that I can't find communications when I need it, see who they are communicating with and about what (topic/keyword). It also enables them to maintain a personal data, topic/keyword and contact map for all communications and easily capture, back-up, search and map a complete record of all communications, so that that they can manage the risk that they can't find communications when they need it.

In some implementations, the invention also provides a free tool to easily send large files, so that they can get information to people quickly.

In some embodiments, small business owners such as a building company owner are provided with a tool to easily capture, back-up, search and map a complete record of all of the company's communications with all business partners, clients and suppliers so that they can get control of their company's communications and easily search across all email accounts, see contractual problems as they arise to manage my risk and reduce disputes and minimize the costs of any disputes and discovery by having an independent record.

IT managers at companies can use the invention to easily capture, back-up, search and map a complete record of all a company's communications with all business partners, clients and suppliers so that they can provide a complete record to the business of all communications cost effectively—without needing to invest in expensive and difficult to manage IT infrastructure.

The following table summarises ways in which certain embodiments of the invention differ from previously available tools:

| Capability | Different to |
|---|---|
| Operates concurrently with | All other |
| the base program, capturing | communication |
| the interaction at the time of | software. |
| sending/receiving passively. | |
| Maintains only one copy of the | Traditional email |
| interaction and any attachments, | and non-web- |
| irrespective of the number | to-web |
| of participants. | communications. |
| Each participant accesses the | |
| same copy of the interaction | |
| and can do so concurrently. | |
| An interaction cannot be | All other |
| deleted without the consent | communication |
| of the sender and all recipients. | software. |
| Interactions can be | Traditional email. |
| aggregated-for | |
| example across source | |
| or organization. | |
| Searching can happen across | Traditional email |
| all interactions using | |
| traditional searching tools- | |
| subject, key word, participant. | |
| Uses a graphical tool to | All |
| illustrate network | communication |
| characteristics. | |

Every communication is tagged to both parties' email address and linked into common record. It captures all in and outbound email, tweets, chats between you and partner I network companies. Communications are captured by way of plugins for Outlook and other email clients, and API feeds for web-based services, automatically sending a copy of the mail to the repository and recording the various metadata associated with the communication, such as the sender, the recipient, the time and date of receipt and any other characteristics of the mail. Attachments are also filed in the same way and linked to the communication.

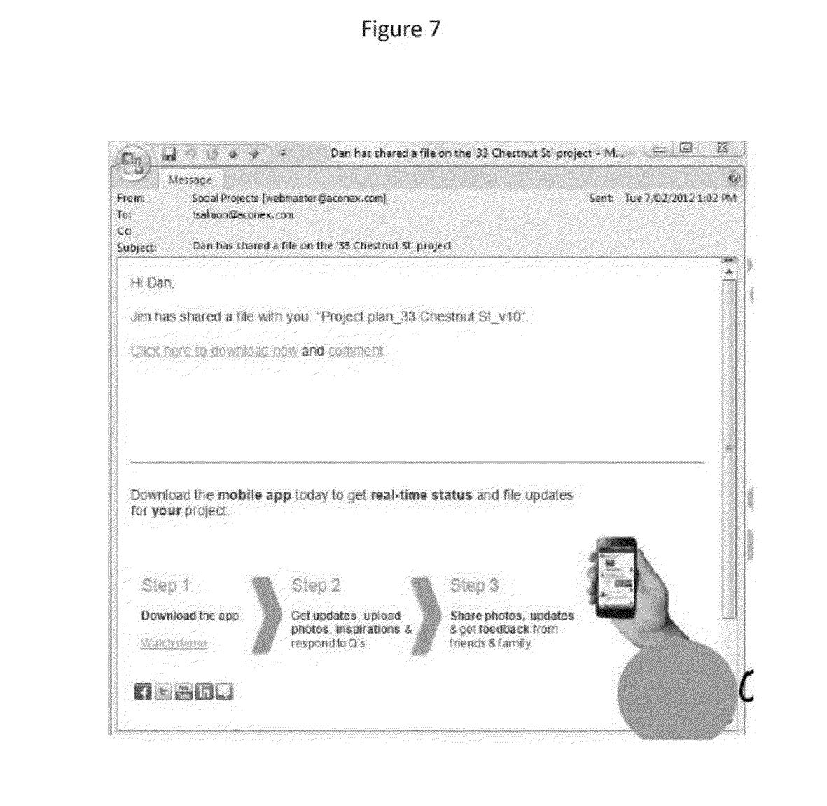

Initially, not all mail recipients maybe members of the platform, so non-members of designated mails will be invited to join the network when they receive the mail. In the meantime, their mails will be stored against their email addresses. As soon as that email address holder joins, all of those mails will be accessible and searchable. Upload previous sent items into record. FIG. 7 depicts an example email according to one implementation of this embodiment in which links and instructions as to how to sign up to the service of the invention are included.

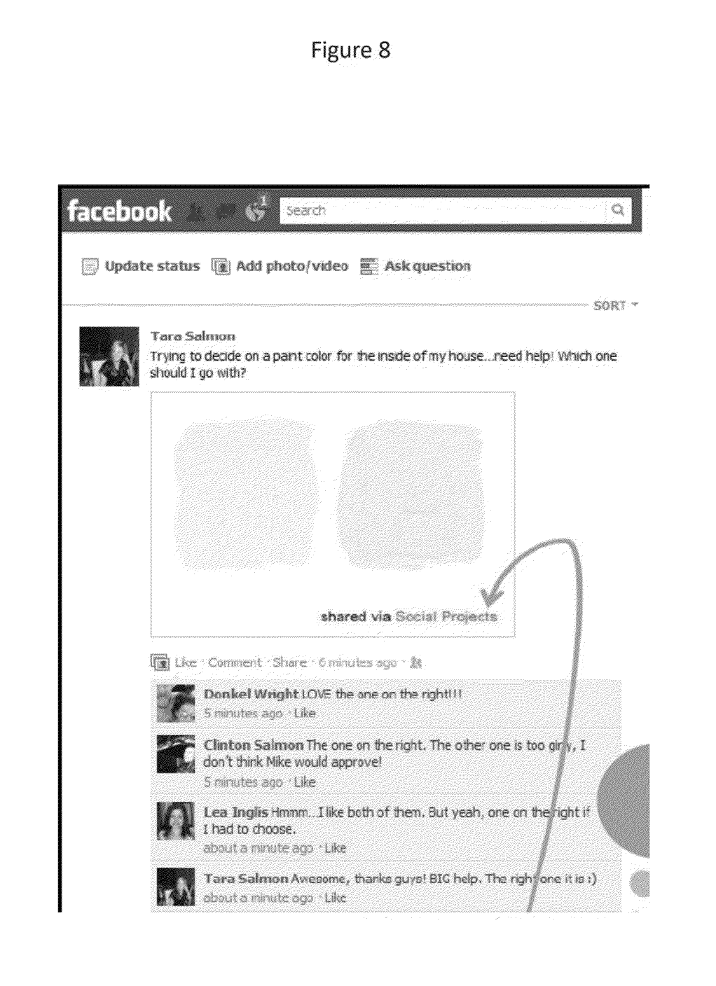

In some implementations, the system integrates with third party social media platforms to enable users to share information about the project on those platforms and at the same time ‘spread the word’ about the system of the invention. FIG. 8 provides an example of such a communication in which a user is asking for opinions relating to paint colour within the facebook platform.

All communications are searchable using an indexed search engine. Users can search across all communications they have received and for members of a domain (such as a company), across all communications sent or received by any member within that domain.

In some implementations, a user may decide that they do not want any personal mail to be captured. The user can therefore deselect a mail for capture at the time of sending. However this would not stop the recipient from filing the mail.

### EXAMPLE 2

In this example, the system and method of the invention is referred to as the ‘Easy As’ offering and relates to the area of building construction project management.

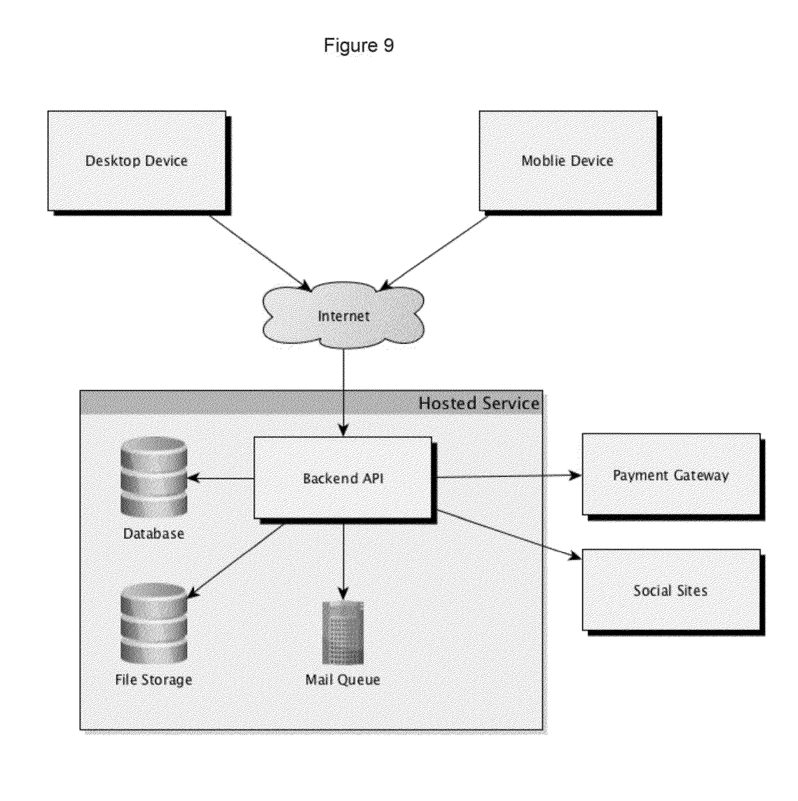

FIG. 9 depicts an example high level technical architecture according to certain embodiments of the invention. In this example, the Easy As architecture primarily consists of a Software as a Service (Saas) offering that may be accessed through the Internet from a range of different devices, such as desktop web browsers or native mobile client applications.

In the embodiments depicted in FIG. 9 the hosted service comprises databases, file storage and a mail queue integrated with the backend API (Application Programming Interface). In this embodiment, the payment gateway and social sites access the backend API. A user can access the hosted service via the internet, and for example using a desktop or mobile device.

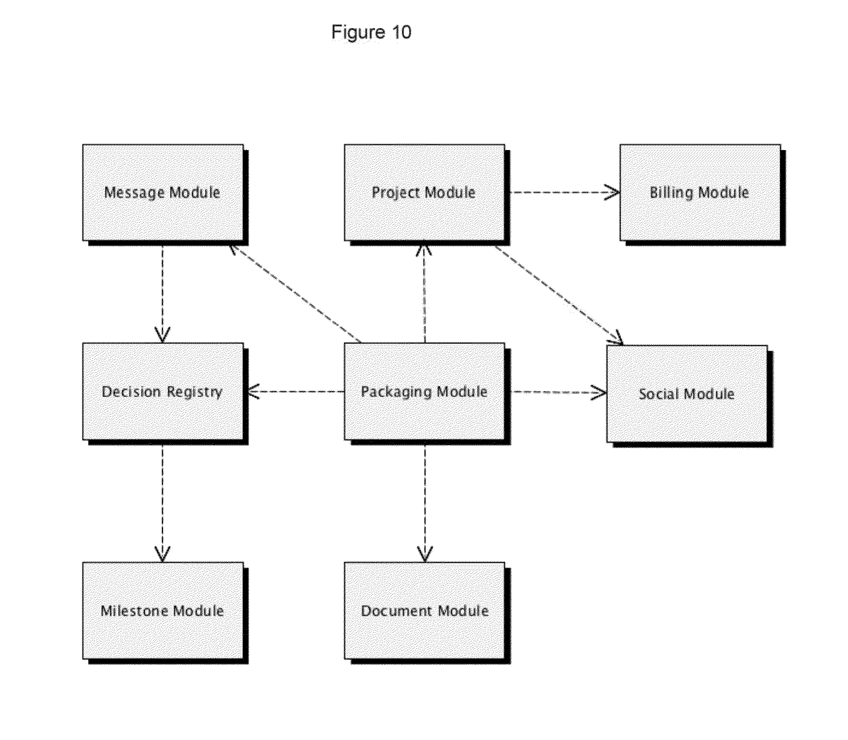

FIG. 10 is a class diagram of the high level components of certain embodiments of he invention. In this example embodiment:
The Project module manages aspects of registering projects on the system. This may for example includes all information for projects, including participants.
The billing module contains information about billing and payment information of the system. It is also responsible for providing or denying access to projects depending on whether payments are up to date.
The messaging module provides users with the ability to send messages and keep track of conversations.
The document module will allow for the management of documents, which includes multimedia files such as photos or videos. It allows for reviewing and versioning of documents to facilitate collaboration between different parties.
The milestone module manages the schedule and milestones for each project. Users are able to configure custom milestones for each project and confirm when each milestone has been reached.
The social module allows users to push notifications and events to social media such as Facebook, Twitter, Pinterest and others.
The decision registry maintains key decision points that have been made during the process. Decisions can come from different sources, for example at end of a threaded discussion or at a particular version of a document.
The packaging module produces a report that is packaged in a concise and visually appealing manner. Events such as photo uploads, milestones and key decisions will be presented on a timeline along with information from other sources like weather or news channels.

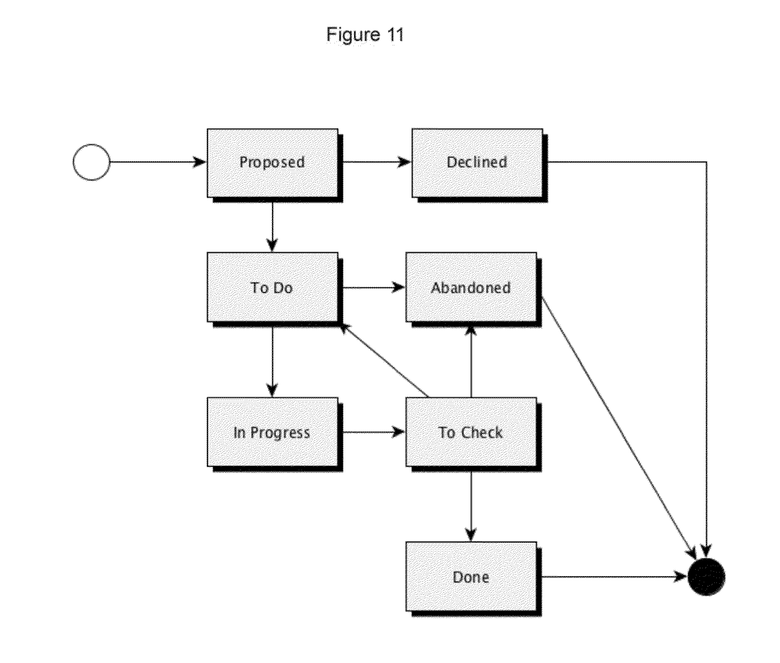

FIG. 11 is a state transition diagram of milestones according to the exemplary embodiments of FIG. 10. It will be appreciated that milestones are a key element of running a project such as the building construction schedule of this example.

FIG. 12 is an interaction diagram depicting an example process flow for a user signing in. The user signs into the system and may use pre-defined credentials (such as those used for facebook, Google+, OpenID), or any other suitable single sign on or social media provider. After the first sign-on the system creates a new user profile which may be modified by the user at any time.

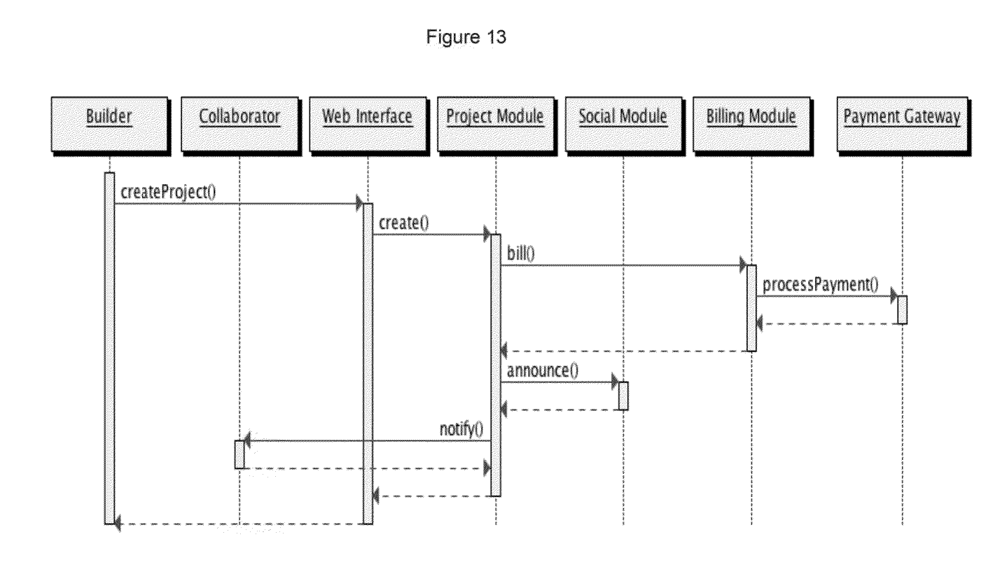

FIG. 13 is an interaction diagram depicting an example process flow for a builder registering a new project in some exemplary embodiments When new projects are registered billing is issued and payment collected. Other collaborators on the project such as sub contractors, the architect and the building owner are notified. The project is announced on Social Media sites which may for example be pre-selected.

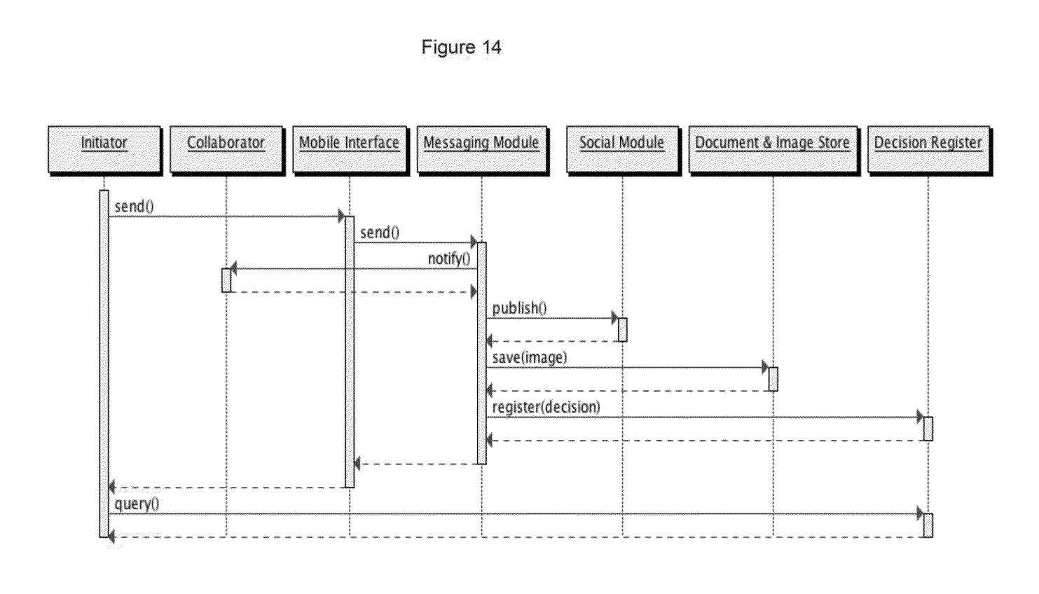

FIG. 14 is an interaction diagram depicting an example process flow for certain messaging and information sharing options according to some exemplary embodiments. The systems allows users to send messages to other collaborators in the project. The simplest message format is a threaded discussion. Messages may contain photos of the building site or documents related to the building. Threaded discussion may also result in final decisions that are registered in the decision register for future reference of project decisions. At every stage messages or parts of messages may be elected to be posted on social media channels.

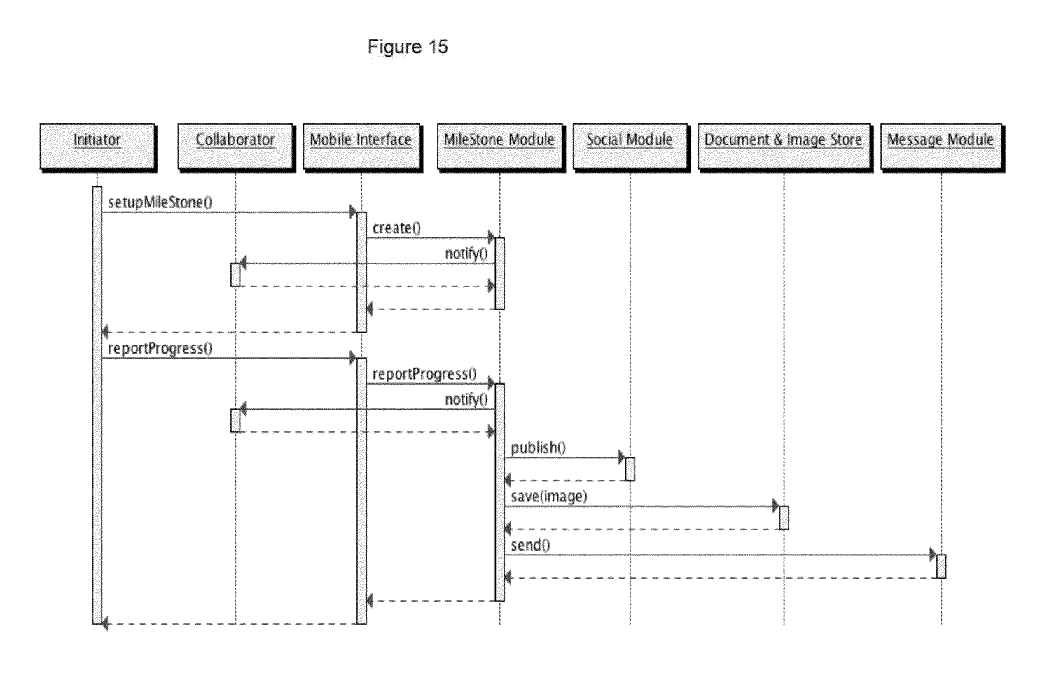

FIG. 15 is an interaction diagram depicting an example process flow for configuring and publishing building milestones according to some exemplary embodiments. The system allows project users to configure milestones and a schedule relating to each milestone. When milestones are created or modified other collaborators on the project are notified. A builder can record project progress against a milestone and schedule. Progress reports can optionally contain supporting material such as plans or photos of the building site. Other collaborators are notified of progress reports via the system or Social Media channels.

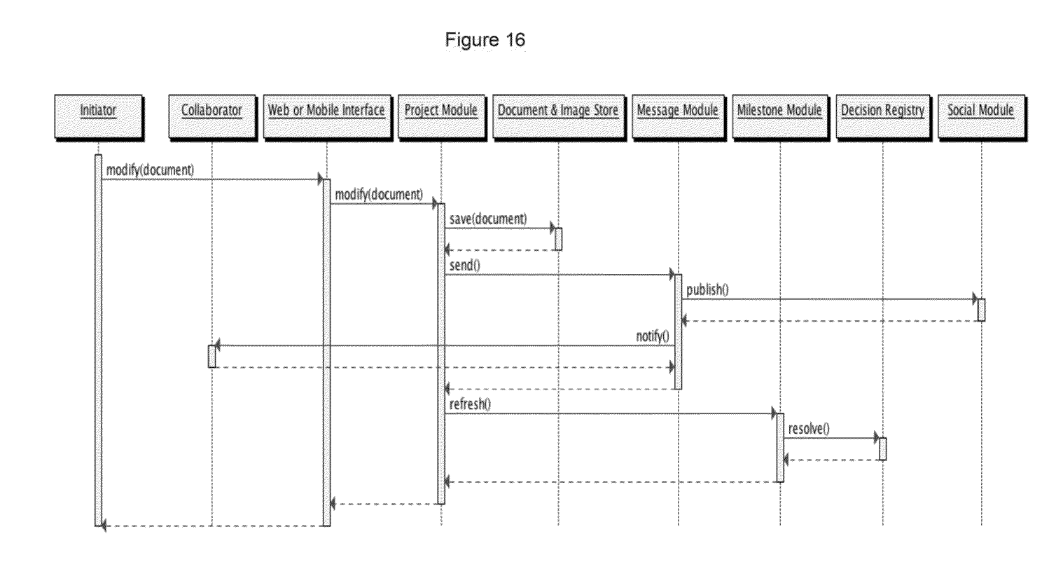

FIG. 16 is an interaction diagram depicting an example process flow for collaborating on documents and milestones according to some exemplary embodiments. The system allows users to collaborate around various files such as documents, photos and milestones. Versioned copies of documents are hosted on the system and users can enter in conversations around these documents via the messaging system or publish documents (e.g. photos) to Social Media sites. Documents are used as the base material for final decisions which are recorded in the decision register.

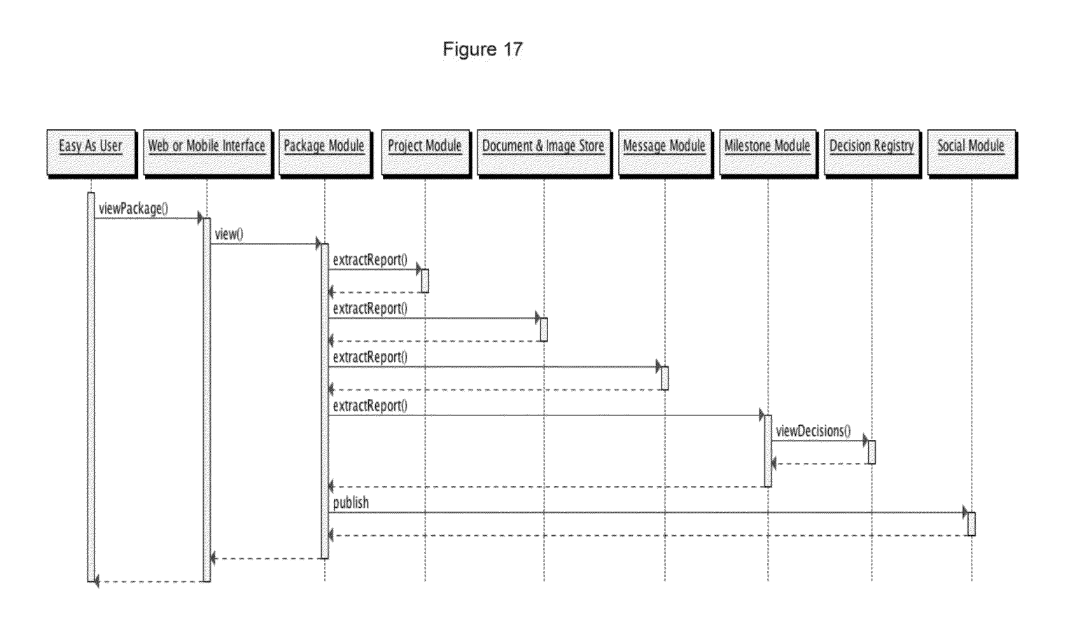

FIG. 17 is an interaction diagram depicting an example process flow for packaging and reporting according to some exemplary embodiments. A user requests a packaged report that contains all the information captured for a given project in a concise format. The package contains a summary of all sub systems over the duration of the project and can be published to Social Media platforms.

1. A project management system, comprising: at least one social media tool to increase an effectiveness of communicating information associated with the project.

2. A computer implemented method, comprising: storing data associated with a project in a data store, associating at least one user with the project using at least one data type, and providing a communication tool to enable the user to communicate to another person about the project.

3. The project management system according to claim 1, comprising: a processor executing instructions stored on a memory; and the memory comprising: a data storage module configured to store information about the project; a user data module configured to associate at least one user with the project, using at least one data type and a communication module to enable the user to communicate to another person about the project.

4. The computer implemented method according to claim 2 for communicating about a project, comprising: outputting by a server device an information interface for display by a client device and thereby providing the user with an ability to communicate about a project; receiving by a server device at least one instruction from the user in relation to the project; and enabling communication about the project.

5. An apparatus, comprising: a storage device; and a processor coupled to the storage device, wherein the storage device stores a program for controlling the processor, and wherein the processor, being operative with the program, is configured to cause an output by a server device of an information interface for display by a client device and thereby providing a user with an ability to communicate about a project; receiving by a server device at least one instruction from the user in relation to the project; and enabling a communication about the project.

6. The computerized system according to claim 1 for social project management, further comprising; a project module to manage registration of projects on the system; a messaging module to enable a user to send messages and keep track of conversations; a document module to allow for the management of documents; and a milestone module to manage a schedule and/or milestones for each project.

7. The system according to claim 6, further comprising: one or more of: a billing module to manage billing; a social module to enable the user to push notifications and events to social media; a decision registry to maintain one or more decisions that have been made during a process; and a packaging module to produce a report.

8. The method of claim 2, further comprising: a step of associating a plurality of projects with one another.

9. The system according to claim 1, further comprising: at least one search module to enable a search.

10. The method of claim 2, further comprising: steps of receiving a search instruction via a user interface; conducting a search according to the search instruction and optionally a predefined criterion; and displaying one or more search results.

11. The method of claim 10, wherein the predefined criterion comprises a restriction based on the user's access privileges.

12. The method of claim wherein the search is optionally: across one or more projects; for the user, a document, a type of project.

13. The method of claim 10, wherein the search is for the user to collaborate with or to provide a service.

14. The system of any one of claim 1, further comprising: a rating module to enable a first user to add information about a second user wherein the information is optionally a rating information and/or a recommendation information and the second user is optionally a service provider or a collaborator.

15. The method of claim 2, further comprising: a step of receiving from the user, information relevant to a second user, wherein the information optionally comprises rating information and/or recommendation information and wherein the second user is optionally a service provider or a collaborator.

16. The system according to claim 2, further comprising: a marketing module to enable marketing messages to be displayed in the system.

17. The method of claim 2, further comprising: steps of receiving and/or collecting marketing information relevant to one or more users and/or one or more projects; receiving at least one instruction in relation to marketing; and displaying a marketing message to a user wherein the marketing message is optionally displayed once a predetermined criterion is met.
